(19) United States
(12) Patent Application Publication
(10) Pub. No.: US 2007/0203850 A1
(43) Pub. Date: Aug. 30, 2007

(54) Multifactor authentication system

(75) Inventors: Moneet Singh, Conshohocken, PA (US); Richard A. Rasansky, Narberth, PA (US); Jeffrey Racho, Conshohocken, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Sapphire Mobile Systems, Inc.

(21) Appl. No.: 11/706,667

(22) Filed: Feb. 14, 2007

Related U.S. Application Data
(60) Provisional application No. 60/773,620, filed on Feb. 15, 2006.
(60) Provisional application No. 60/831,818, filed on Jul. 18, 2006.

(51) Int. Cl. H04L 9/00

(52) U.S. Cl. 705/67

(57) ABSTRACT

Systems and methods are provided to allow for multifactor authentication of automatic teller machines (ATM) transactions and transactions at a merchant's point of sale. In an illustrative implementation, a secondary PIN request is delivered to participating users, and/or a one-time use, randomly generated secondary PIN to a customer's mobile phone via a text message when the customer initiates a transaction at an ATM. The customer then replies with a text message to the secondary PIN request with the customer's PIN or inputs the secondary PIN into the ATM before the transaction may proceed. In an illustrative implementation, the customer's mobile phone is allowed to be used as a mobile PIN terminal for various payments devices used at a merchant's point of sale system. Also, an additional level of customer authentication using the ubiquitous mobile phone can be allowed, thereby increasing the security of ATM transactions and non-cash payments.

### CLAIM OF PRIORITY AND CROSS REFERENCE

This non-provisional patent application claims priority to and the benefit of U.S. provisional application No. 60/773,620, filed Feb. 15, 2006, entitled “TWO-STEP CUSTOMER AUTHENTICATION PROCESS FOR ATM ACCESS,” and U.S. provisional application No. 60/831,818, filed Jul. 18, 2006, entitled “TWO-FACTOR AUTHENTICATION SYSTEM FOR A MOBILE PAYMENTS SYSTEM INVOLVING A PAYMENTS DEVICE EQUIPPED WITH RFID/NFC CAPABILITIES,” which are herein incorporated by reference in their entirety.

### BACKGROUND

Automated Teller Machines (ATMs) generally use a four digit personal identification number (PIN) to authenticate a banking customer who wishes to withdraw money from the ATM using an ATM card. The four digit PIN, long the standard art for user authentication in the financial industry, may be replaced by a PIN of six digits in the near future in order to increase the security of user access to ATMs.

Although a six-digit PIN can offer a level of security greater than that offered by a four digit PIN, an overlay of an additional step to the current four-digit PIN standard may provide a higher level of security than simply increasing the PIN digit length.

The Short Message Service (“SMS”), often referred to as “text messaging,” allows digital mobile phones and other mobile communications devices to remit messages of up to one hundred and sixty characters in length over the mobile communications network to other mobile phone users. The use of SMS has grown significantly in recent years and all new mobile phones have the ability to send/receive SMS messages.

Mobile payment systems based upon near field communications (NFC) technology, such as radio frequency identification (RFID) systems, have begun to enter the marketplace as evidenced by systems such as the “Speedpass” contactless payment system used at ExxonMobil gas stations. NFC and RFID systems, however, have not seen “steal” an NFC/RFID radio code using a type of scanner or could simply steal the physical fob or device used to transmit the NFC/RFID radio code.

“Multifactor authentication” generally refers to a security authentication system in which more than one form of authentication is used to validate the identity of a user. For example, a webpage which asks a user to remit a single username/password combination may be considered a “single-factor” authentication system since it requests a single datum—a username/password combination—in order to validate a user's identity. The webpage may add additional procedures, such as checking the user's internet protocol (IP) address against a list of pre-approved IP addresses or sending a confirmation email to the user's verified email address, in order to add additional levels of user authentication, thereby implementing a “multifactor authentication” system for the webpage.

The Federal Financial Institutions Examination Council (FFIEC) has mandated that banks and financial institutions implement multifactor authentication systems for online access to accounts deemed to be “high risk.” It is expected that banks and financial institutions can seek to adopt multifactor authentication systems for all of their online account customers in the near future.

From the foregoing it is appreciated that there exists a need for systems and methods to ameliorate the shortcomings of existing practices used for authentication of users in payment processing.

### SUMMARY

Systems and methods are provided to allow for financial institutions or payments processors to provide a multifactor authentication system for consumers using ATMs or paying for goods at a point of sale. In an illustrative implementation, the herein described systems and methods allows financial institutions or payments processors to remit to or receive a secondary PIN from a customer's mobile phone as the customer attempts to access an ATM. In another illustrative implementation, the herein described systems and methods allows payments processors to receive a PIN from a customer's mobile phone as the customer attempts to pay for an item using one of a plurality of different payment methods as a point of sale (POS).

In an illustrative implementation, an exemplary multifactor authentication system comprises a “Multifactor Authentication” engine and a computing environment which may be operated by a financial institution, payment processor or a third party. In the illustrative implementation, the multifactor authentication system comprises at least one instruction set providing at least one instruction to the “Multifactor Authentication” engine to process data representative of user authentication requests. Users of the multifactor authentication system implementing the herein described systems and methods can generally interact with it using text messages delivered via the Short Message Service (SMS) or the Multimedia Messaging Service (MMS), although other means of communication, such as by a interactive voice response (IVR) system, are possible.

Other features of the herein described systems and methods are described further below.

### BRIEF DESCRIPTION OF THE DRAWING

Referring now to the drawing, in which like reference numbers refer to like elements throughout the various figures that comprise the drawing. Included in the drawing are the following figures:

FIG. 1 is a block diagram of an exemplary “Multifactor Authentication” environment depicting the components comprising the herein described systems and methods in accordance with the herein described systems and methods;

FIG. 2 illustrates an ATM-based process undertaken by an illustrative implementation of the herein described systems and methods;

FIG. 2A is a block diagram of an exemplary multifactor authentication environment in accordance with the herein described systems and methods;

FIG. 3 illustrates an ATM-based process undertaken by an illustrative implementation of the herein described systems and methods;

FIG. 4 illustrates an point of sale (POS) based process undertaken by an illustrative implementation of the herein described systems and methods;

FIG. 5 illustrates a flow chart diagram of an illustrative implementation of the herein described systems and methods.

### DETAILED DESCRIPTION

### Overview

Financial institutions and payments processors may use the method and system described herein to better protect their customers by adding multifactor authentication capabilities to ATMs and POS payment devices. The herein described systems and methods can be embodied in an information technology system, such as an electronic system used for mobile commerce transactions using mobile or other electronic communications. A person skilled in the arts of computer programming, information technology system architectures, information technology system design and electronic communications technologies may adapt the herein described systems and methods to various information technology systems regardless of their scale.

In one implementation of the method and system described herein, a customer can pre-set a secondary PIN for access to his/her ATM account. The secondary PIN may be pre-set at an online banking portal or by a phone system specified by the bank. The customer can also register his/her mobile phone at the online banking portal or by a phone system specified by the bank. When the customer arrives at an ATM, he/she can enter in his/her primary PIN in the ATM, which then validates the primary PIN. After this validation, the ATM's network, by implementing the “Multifactor Authentication” environment, can remit to the customer's registered mobile phone via the wireless telecommunications network a SMS message requesting that the customer reply to the message with his/her secondary PIN. The customer can compose a SMS message in response to the “secondary PIN request” SMS message and deliver it to the “Multifactor Authentication” environment. If the secondary PIN is successfully validated, then the ATM can allow the customer access to the machine. As seen in this implementation, the method and system modifies the single-factor authentication of the ATM (which was dependent solely upon one PIN) to a multifactor authentication system which requires a total of three forms of authentication: knowledge of the primary PIN, knowledge of the secondary PIN, and possession of the registered mobile phone.

In another implementation of the method and system described herein, a customer can pre-set a secondary PIN for access to his/her ATM account. The secondary PIN may be pre-set at an online banking portal or by a phone system specified by the bank. The customer can also register his/her mobile phone at the online banking portal or by a phone system specified by the bank. When the customer arrives at an ATM, the customer can enter the customer's primary PIN in the ATM, which then validates the primary PIN. After this validation, the ATM's network, by implementing the “Multifactor Authentication” environment, can remit to the customer's registered mobile phone via the wireless telecommunications network a SMS message with a temporary one-use secondary PIN and request that the customer enter this temporary one-use secondary PIN into the ATM when prompted to do so. If the temporary one-use secondary PIN is successfully validated, then the ATM can allow the customer access to the machine. As seen in this implementation, the method and system modifies the single-factor authentication of the ATM (which was dependent solely upon one PIN) to a multifactor authentication system which requires a total of three forms of authentication: knowledge of the primary PIN, knowledge of the temporary one-use secondary PIN, and possession of the registered mobile phone.

In another implementation of the method and system described herein, a customer with a cell phone and a payments device (which can even be the phone itself) presents the payments device to a merchant who is equipped to accept payments made using the payments device. The merchant's POS system remits the identification of the payments device to a payments processor, who then sends an SMS message to the customer's cell phone. The SMS message contains a PIN request; the customer then can send a reply SMS message with the customer's PIN. If the PIN is correct, the payments processor authorizes the transaction and notifies the merchant to allow the transaction. In this implementation, the customer's phone may also act as a keypad for PIN-based debit transactions, thereby enabling merchants lacking a keypad at the POS to accept PIN-based debit cards.

### Exemplary “Multifactor Authentication” Environment

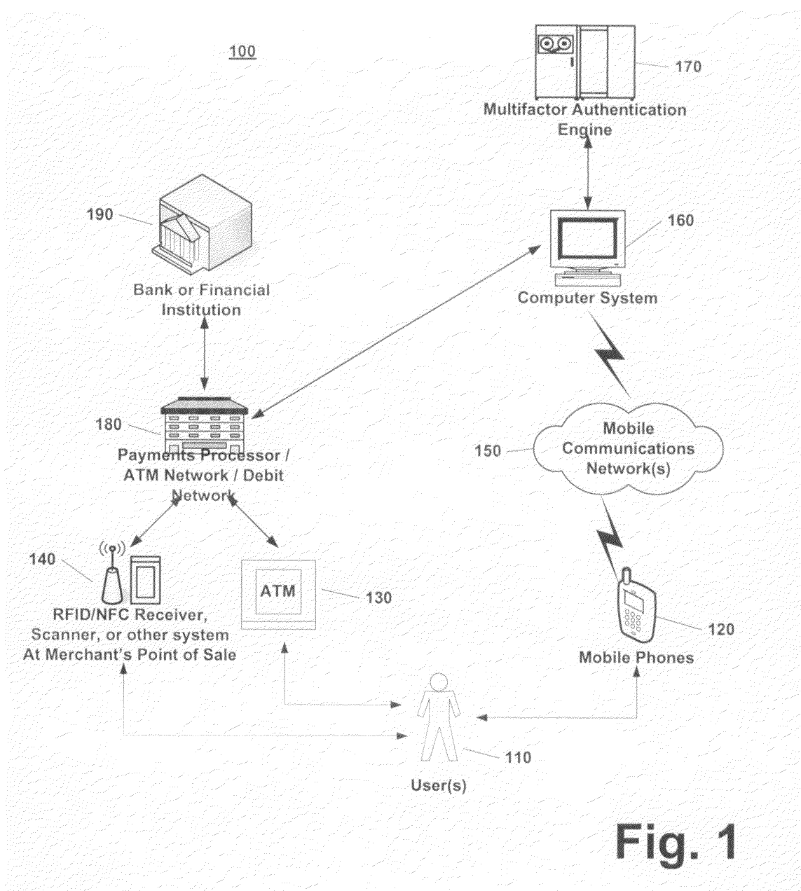

FIG. 1 illustrates the exemplary “Multifactor Authentication” Environment 100, which comprises users 110 (e.g., customers); mobile phones 120 owned/used by the users; ATMs 130; a merchant's point of sale system 140 which may have an RFID/NFC receiver, barcode scanner, swipe system or other payment device acceptance hardware; the mobile telecommunications network 150; a computer environment 160; a Multifactor Authentication Engine 170; payments processors, ATM networks or debit networks 180; and banks or financial institutions 190. The exemplary “Multifactor Authentication” environment 100 may be implemented by a bank, a payments processor or a third party.

It is appreciated that, although the exemplary “Multifactor Authentication” Environment 100 is described to employ specific components having a particular configuration, such description is merely illustrative as the inventive concepts described herein can be performed by various components in various configurations.

### Illustrative Processes when Using the Herein Described Systems and methods

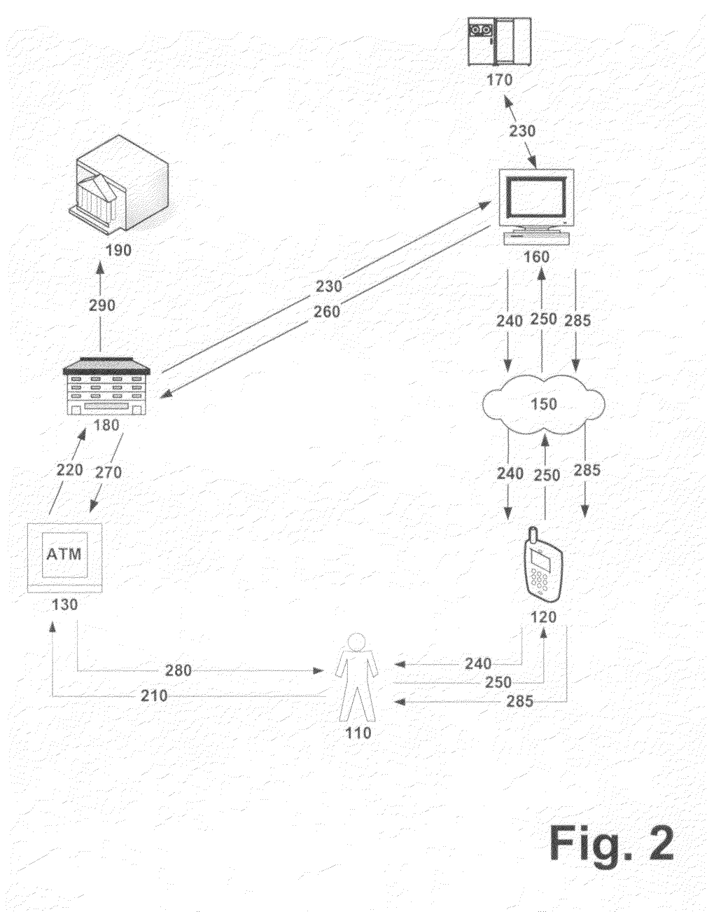

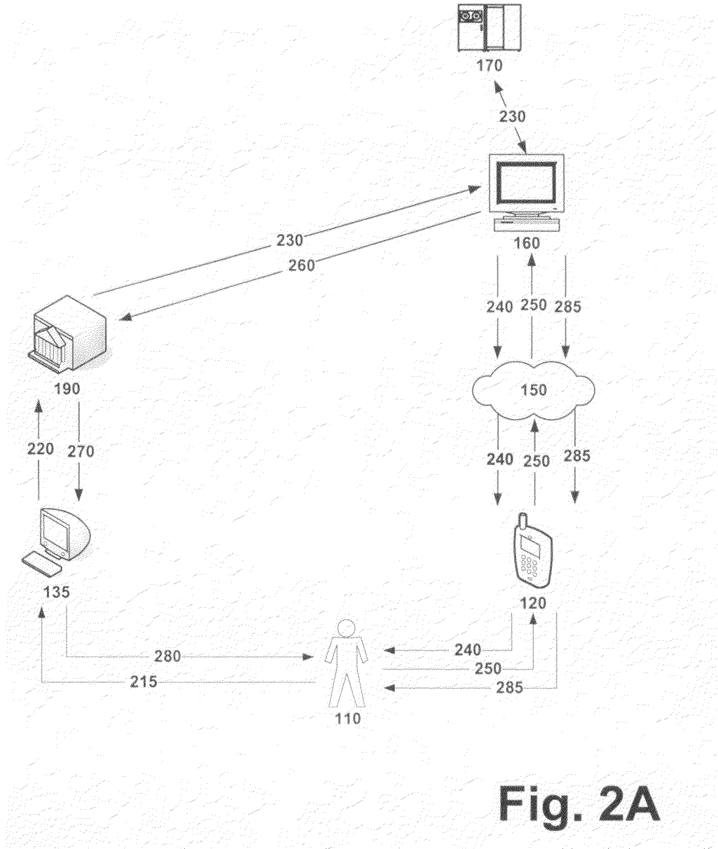

It is appreciated that the exemplary “Multifactor Authentication” Environment 100 of FIG. 1 can maintain various operations and features. FIGS. 2, 2A. 3 and 4 provide illustrative embodiments of exemplary processing by the exemplary “Multifactor Authentication” environment 100.

As is shown in FIG. 2, an illustrative process begins when a user 110 with a mobile phone 120 approaches an ATM 130 and inserts the user's ATM card into the ATM 210 in order to complete a transaction with the user's bank 190. The customer can then enter the PIN the user normally employs for ATM access, referred to as a “Primary PIN.” The ATM can then authenticate the user's Primary PIN 220 over the ATM network or with a payments processor 180.

If the Primary PIN is incorrect, ATM 130 ends the transaction. If the Primary PIN is correct, the ATM network or payments processor then instructs (as shown by arrow 230) a computer environment 160 which operates a “Multifactor Authentication” Engine 170 to remit a Secondary PIN request to the user. The computer environment and “Multifactor Authentication” Engine send a Secondary PIN request (as is shown by arrow 240) to the user's mobile phone 120 via the mobile communications network 150. The Secondary PIN request may take the form of an SMS message, such as “Please submit your Secondary PIN to this phone number or SMS short code.” It should be noted that the user's mobile phone number has been pre-registered with the computer environment and “Multifactor Authentication” Engine.

The user 110 receives the Secondary PIN request (as shown by arrow 240) on the user's mobile phone 120. The user then keys in the Secondary PIN on the user's mobile phone 120 and sends it via a Response Message in SMS format (as is shown by arrow 250) to the phone number or short code from which the Secondary PIN request was delivered from the computing environment 160 and “Multifactor Authentication” engine 170. The SMS messages comprising the Secondary PIN request (as is shown by arrow 240) and the customer's reply (as is shown by arrow 250) may include other types of security measures in order to increase the security of the transaction and allow the computing environment 160 and “Multifactor Authentication” engine 170 to verify the identity of the sender of the SMS messages which they receive.

The Response Message can then be received (as is shown by arrow 250) by the computing environment 160 and “Multifactor Authentication” engine 170, which then verify the Secondary PIN as correct and also verify that the phone number of the mobile phone from which the Response Message was sent matches the user's mobile phone number which has been pre-registered with the computer environment and “Multifactor Authentication” Engine. If the Secondary PIN or identified mobile phone number are incorrect, the computing environment and “Multifactor Authentication” engine may remit a second Secondary PIN request message (as is shown by arrow 285), and subsequently end the transaction if the Response Messages to the first and second Secondary PIN requests are incorrect.

If the Secondary PIN in the Response Message 250 is correct, the computing environment 160 and “Multifactor Authentication” engine 170 can instruct the ATM network or payments processor 180 to allow the user's transaction to proceed 260. The ATM network or payments processor can then instruct the ATM 130 to allow the user's transaction, which is then completed 280 by the user 110. The ATM network or payments processor then finalizes the transaction 290 with the user's bank 190.

In this illustrative process, the herein described systems and methods illustratively operating as a secondary PIN terminal, offers an additional level of security to the ATM transaction. If the customer's ATM card and Primary PIN have been stolen by a thief, the thief can be unable to access the customer's ATM account because he does not have the customer's mobile phone and can be unable to receive and reply to the Secondary PIN request. Should the thief also be in possession of the customer's mobile phone, the thief can also need the Secondary PIN in order to remit the Response Message. As the Secondary PIN and the Primary PIN are suggested to be two different alphanumeric strings, possession of only the Primary PIN can not allow the thief to access the customer's account. This illustrative process is the preferred embodiment of the herein described systems and methods.

FIG. 2A depicts another illustrative process for multi-factor authentication. In this illustrative operation, he ATM can be replaced by a bank's online portal 135 available via the Internet to users 110. As depicted in FIG. 2A, a user 110 can attempt to login to a bank's Internet site 215 through an Internet-enabled computer or phone 135. After submitting the user's username and primary password, which must be verified as correct by the bank before the process may proceed, the bank 190 can instruct 230 a computer environment 160 which operates a “Multifactor Authentication” Engine 170 to remit a Secondary PIN request 240 to the user's mobile phone 120. The computer environment 160 and “Multifactor Authentication” Engine can then send a Secondary PIN request 240 to the user's mobile phone 120 via the mobile communications network 150. The Secondary PIN request may take the form of an SMS message, such as “Please submit your Secondary PIN to this phone number or SMS short code.” It should be noted that for the purposes of the illustrative operation, the user's mobile phone number has been pre-registered with the bank and/or computer environment and “Multifactor Authentication” Engine.

The user 110 receives the Secondary PIN request 240 on the user's mobile phone 120. The user can then key in the Secondary PIN on the user's mobile phone 120 and sends it via a Response Message in SMS format 250 to the phone number or short code from which the Secondary PIN request was delivered from the computing environment 160 and “Multifactor Authentication” engine 170. The SMS messages comprising the Secondary PIN request 240 and the customer's reply 250 may include other types of security measures in order to increase the security of the transaction and allow the computing environment 160 and “Multifactor Authentication” engine 170 to verify the identity of the sender of the SMS messages which they receive.

The Response Message can then received 250 by the computing environment 160 and “Multifactor Authentication” engine 170, which then can verify the Secondary PIN as correct and also verify that the phone number of the mobile phone from which the Response Message was sent matches the user's mobile phone number which has been pre-registered with the computer environment and “Multifactor Authentication” Engine. If the Secondary PIN or identified mobile phone number are incorrect, the computing environment and “Multifactor Authentication” engine may remit a second Secondary PIN request message 285, and subsequently end the transaction if the Response Messages to the first and second Secondary PIN requests are incorrect.

If the Secondary PIN in the Response Message 250 is correct, the computing environment 160 and “Multifactor Authentication” engine 170 can instruct the bank 190 to allow the user's attempt to access the bank's Internet site through a computer or mobile phone 135 to proceed 260. The bank can then allow the user access to the bank's Internet portal 280.

In this illustrative process, the herein described systems and methods offers an additional level of security to access to the bank's Internet site. If the customer's username and primary password have been stolen by a thief, the thief can be unable to access the customer's online account at the bank because he does not have the customer's mobile phone and can be unable to receive and reply to the Secondary PIN request. Should the thief also be in possession of the customer's mobile phone, the thief can also need the Secondary PIN in order to remit the Response Message. As the Secondary PIN and the username and primary password are suggested to be different alphanumeric strings, possession of only the username and primary password can not allow the thief to access the customer's online banking account.

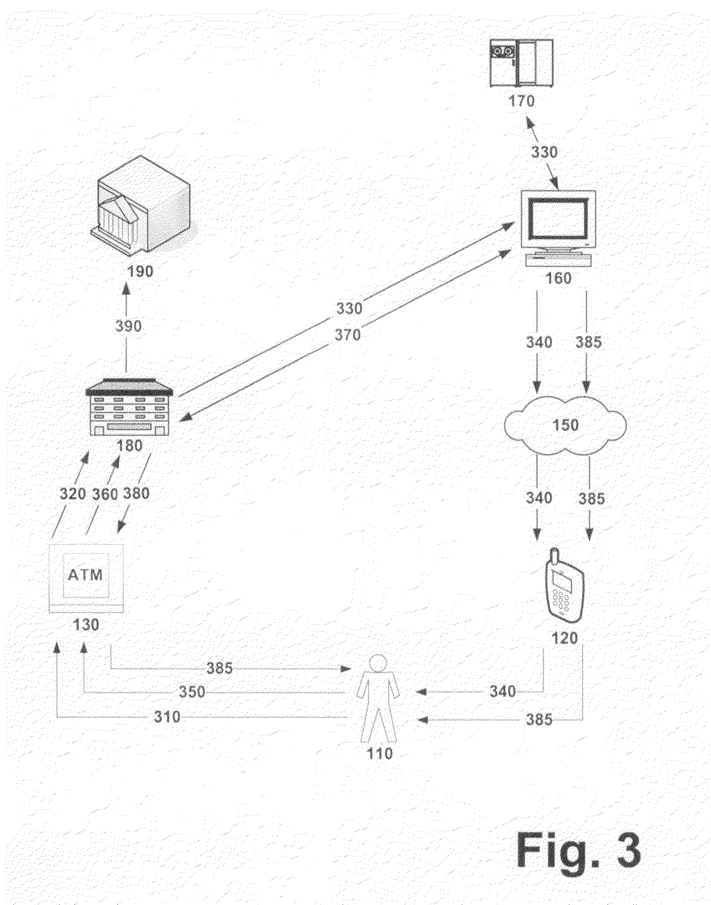

As is shown in FIG. 3, an illustrative process begins when a user 110 with a mobile phone 120 can approach an ATM 130 and inserts the user's ATM card into the ATM 310 in order to complete a transaction with the user's bank 190. The customer then enters the PIN the user normally uses for ATM access, referred to as a “Primary PIN.” The ATM then authenticates the customer's Primary PIN 320 over the ATM network or with a payments processor 180.

If the Primary PIN is incorrect, the ATM ends the transaction. If the Primary PIN is correct, the ATM network or payments processor then instructs 330 a computer environment 160 which operates a “Multifactor Authentication” Engine 170 to remit a Secondary PIN to the user. This Secondary PIN may be a “one-time use” PIN randomly generated by the computer environment and “Multifactor Authentication” Engine. The computer environment and “Multifactor Authentication” Engine generate a Secondary PIN and send it 340 to the user's mobile phone 120 via the mobile communications network 150. The Secondary PIN may be delivered to the user's mobile phone in the form of a Secondary PIN Delivery SMS message. The Secondary PIN Delivery may take the form of, for example, “Your one-time Secondary PIN is 123456.” It should be noted that for the purposes of the illustrative operation, the user's mobile phone number has been pre-registered with the bank and/or computer environment and “Multifactor Authentication” Engine.

The user 110 can then receive the Secondary PIN Delivery message 340 containing the Secondary PIN on the user's mobile phone 120. The user can then input the Secondary PIN 350 into the ATM 130 when prompted. The ATM can then submit the Secondary PIN 360 to the ATM network or payments processor 180 which can then authenticate the Secondary PIN as correct 370 with the computer environment 160 and “Multifactor Authentication” Engine 170. Should the Secondary PIN submitted to the computer environment and “Multifactor Authentication” Engine be incorrect, the computer environment can notify the ATM network or payments processor to halt the transaction. In the alternative, the computer environment and “Multifactor Authentication” Engine may submit a subsequent Secondary PIN to the user 385 and the process can begin again.

If the computer environment 160 and “Multifactor Authentication” Engine 170 authenticates the Secondary PIN as correct, then the ATM network or payments processor 180 can notify 380 the ATM to allow the transaction to proceed. The transaction is then completed 385 by the user 110. The ATM network or payments processor then finalizes the transaction 390 with the user's bank 190.

In this illustrative process, the herein described systems and methods illustratively operating as a secondary PIN terminal, can offer an additional level of security to the ATM transaction. If the customer's ATM card and Primary PIN have been stolen by a thief, the thief can be unable to access the customer's account because he does not have the customer's mobile phone and can be unable to receive the Secondary PIN. This illustrative process also offers the benefit of not requiring the customer to remember a Secondary PIN as required in the prior illustrative process. This illustrative process may also be adapted to a bank's online portal in the same manner in which the first described illustrative process of FIG. 2 was adapted as presented in FIG. 2A.

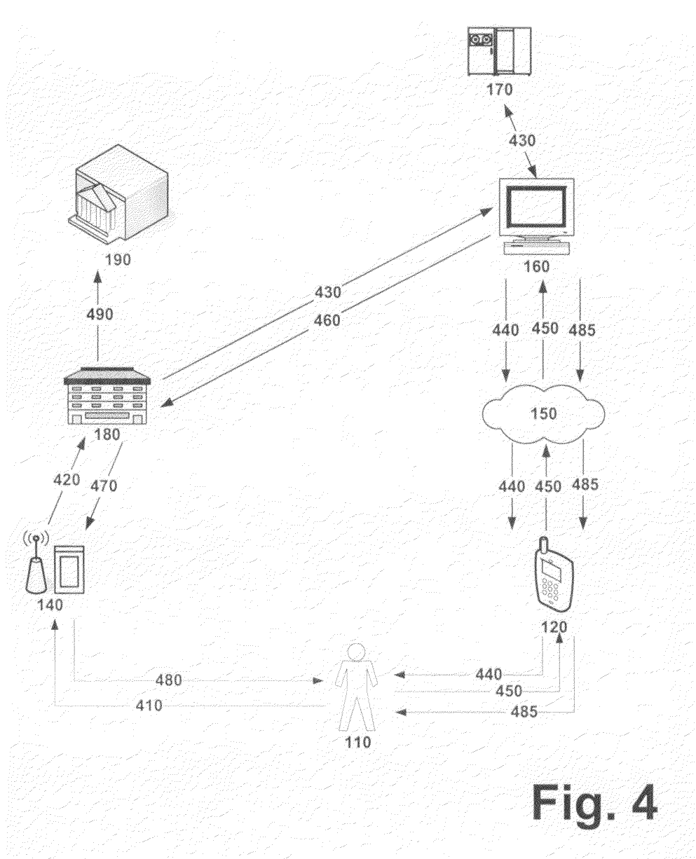

As is shown in FIG. 4, an illustrative process begins when a user 110 with a mobile phone 120 approaches a merchant who has a point of sale device 140, be it a card swipe machine, barcode scanner, or an NFC/RFID receiving antenna. When required to pay for the user's items, the user can use a payment mechanism 410 at the point of sale device.

The payments device may take numerous forms, including but not limited to, a credit card, debit card, card with an integrated NFC/RFID chip, FOB wand, and a cell phone with an integrated NFC/RFID chip. Furthermore, the herein described systems and methods illustratively operate to allow cell phones lacking NFC/RFID capabilities to act as mobile payments devices if the mobile phone is equipped with a “stick-on” NFC/RFID system, such as a small, flat NFC/RFID chip enclosed in plastic with an adhesive strip, or a “stick-on” barcode, such as a bar-code sticker or bar-code embossed plastic piece with an adhesive strip.

The user is afforded the ability to pay for goods using the user's payment mechanism 410 at the point of sale device 140, whereupon the user's payment information is delivered 420 to a payments processor or a debit network 180. The payments processor or debit network can then instruct 430 a computer environment 160 which operates a “Multifactor Authentication” Engine 170 to remit a Secondary PIN request to the user. The computer environment and “Multifactor Authentication” Engine can send a Secondary PIN request 440 to the user's mobile phone 120 via the mobile communications network 150. The Secondary PIN request may take the form of an SMS message, such as “Please submit your Secondary PIN to this phone number or SMS short code.” It should be noted that the user's mobile phone number has been pre-registered with the computer environment and “Multifactor Authentication” Engine.

The user 110 can then receive the Secondary PIN request 440 on the user's mobile phone 120. The user then keys in the Secondary PIN on his/her mobile phone 120 and sends it via a Response Message in SMS format 450 to the phone number or short code from which the Secondary PIN request was delivered from the computing environment 160 and “Multifactor Authentication” engine 170. The SMS messages comprising the Secondary PIN request 440 and the customer's reply 450 may include other types of security measures in order to increase the security of the transaction and allow the computing environment 160 and “Multifactor Authentication” engine 170 to verify the identity of the sender of the SMS messages which they receive.

The Response Message can then be received 450 by the computing environment 160 and “Multifactor Authentication” engine 170, which can then verify the Secondary PIN as correct and also can verify that the phone number of the mobile phone from which the Response Message was sent matches the user's mobile phone number which has been pre-registered with the computer environment and “Multifactor Authentication” Engine. If the Secondary PIN or identified mobile phone number are incorrect, the computing environment and “Multifactor Authentication” engine may remit a second Secondary PIN request message 485, and subsequently end the transaction if the Response Messages to the first and second Secondary PIN requests are incorrect.

If the Secondary PIN in the Response Message 450 is correct, the computing environment 160 and “Multifactor Authentication” engine 170 can instruct the payments processor or debit network 180 to allow the user's transaction to proceed 460. The debit network or payments processor can then notify the merchant 470 through the point of sale device 140 that the user's transaction has been allowed, after which the merchant can allow the user to complete the purchase 480. The debit network or payments processor then finalizes the transaction 490 with the user's bank 190.

In this illustrative process, the payments device may be the user's PIN-based debit card, and the merchant is equipped with a point of sale device with credit card capabilities but no keypad, thereby preventing the merchant from accepting PIN-based transactions. The herein described systems and methods allows cooperating merchants to accept PIN-based transactions because the user's mobile phone can now act as the keypad in which the customer may input his/her PIN and submit it to the debit networks or payments processor.

With reference to FIG. 4, in another illustrative process, the point of sale device is a device at a merchant location 140 at which a customer 110 with a mobile phone 120 may request a line of credit from a merchant. The merchant's device 140 then remits a credit check request 420 to a credit rating agency (CRA) 180, such as EXPERIAN®, which can then instruct 430 a computer environment 160 which operates a “Multifactor Authentication” Engine 170 to remit a credit check confirmation request to the user. The computer environment and “Multifactor Authentication” Engine can send a credit check confirmation request 440 to the user's mobile phone 120 via the mobile communications network 150. The credit check confirmation request may take the form of an SMS message, such as “Please submit your PIN to this phone number or SMS short code so that your CRA may release your credit score to the merchant.” It should be noted that the user's mobile phone number has been pre-registered with the computer environment and “Multifactor Authentication” Engine.

The user 110 can then receive the credit check confirmation request 440 on the user's mobile phone 120. The user can then key in the PIN on his/her mobile phone 120 and can send it via a Response Message in SMS format 450 to the phone number or short code from which the credit check confirmation request was delivered from the computing environment 160 and “Multifactor Authentication” engine 170. The SMS messages comprising the credit check confirmation request 440 and the customer's reply 450 may include other types of security measures in order to increase the security of the transaction and allow the computing environment 160 and “Multifactor Authentication” engine 170 to verify the identity of the sender of the SMS messages which they receive.

The Response Message is received 450 by the computing environment 160 and “Multifactor Authentication” engine 170, which then verify the customer's PIN as correct and also verify that the phone number of the mobile phone from which the Response Message was sent matches the user's mobile phone number which has been pre-registered with the computer environment and “Multifactor Authentication” Engine. If the PIN or identified mobile phone number are incorrect, the computing environment and “Multifactor Authentication” engine may remit a second PIN request message 485, and subsequently end the transaction if the Response Messages to the first and second PIN requests are incorrect.

If the PIN in the Response Message 450 is correct, the computing environment 160 and “Multifactor Authentication” engine 170 can instruct the CRA 180 to allow the user's transaction to proceed 460. The CRA can then deliver to the merchant 470 through the merchant's device 140 information related to the customer's credit score, after which the merchant can allow the requested credit to the customer 480.

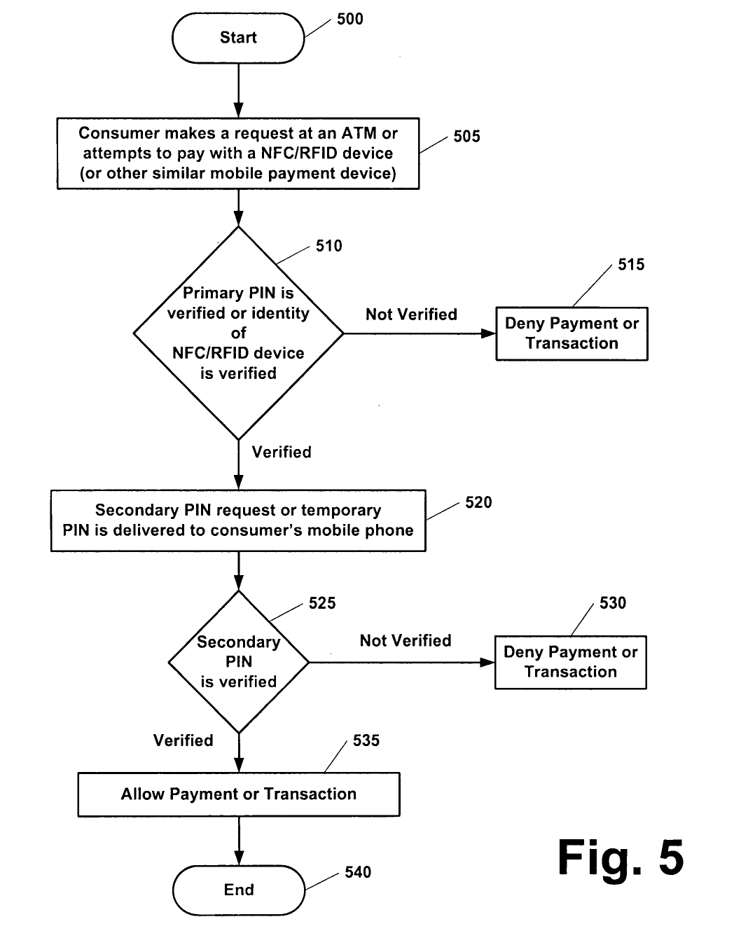

FIG. 5 presents an illustrative process of the herein described systems and methods in the form of a flow chart. At the start 500 of the process, a consumer makes a transaction request at an ATM or attempts to pay for an item using a payments device 505. This transaction request or payment attempt necessitates that the consumer present a first form of authentication, namely, an ATM card and Primary PIN or a payments device such as a debit card, NFC/RFID device or barcode-equipped mobile phone. The first form of authentication is then verified; if the verification fails at block 510, the transaction or payment is denied 515, while if the verification succeeds, the process proceeds to the next step.

After the first form of authentication is verified, the customer receives a request for a second form of authentication, such as a request for a pre-set secondary PIN or a one-time randomly generated secondary PIN delivered to the customer's mobile phone 520. As the customer must be in control of the mobile phone to which the second for of verification is delivered, the possession of the phone itself is a form of additional authentication. The customer then submits the customer's pre-set secondary PIN to the requesting entity or remits the one-time randomly generated secondary PIN to the ATM or another party. The second form of authentication is then verified; if the verification fails, the transaction or payment is denied 530, while if the verification succeeds, the transaction or payment is allowed 535, after which the process ends 540.

It is understood that the herein described systems and methods are susceptible to various modifications and alternative constructions. There is no intention to limit the herein described systems and methods to the specific constructions described herein. On the contrary, the herein described systems and methods is intended to cover all modifications, alternative constructions and equivalents falling within the scope and spirit of the herein described systems and methods.

It should also be noted that the herein described systems and methods may be implemented in a variety of computer environments (including both non-wireless and wireless computer environments), partial computing environments and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described systems and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the herein described systems and methods has been described in detail above, those skilled in the art can readily appreciate that many additional modifications are possible in the exemplary embodiments without materially departing from the novel teachings and advantages of the herein described systems and methods. Accordingly, these and all such modifications are intended to be included within the scope of this herein described systems and methods. The herein described systems and methods may be better defined by the following exemplary claims.

What is claimed is:

1. A system for authenticating the identity of a user attempting a financial transaction comprising:
a multifactor authentication engine; and
an instruction set operable to provide at least one instruction to the multifactor authentication engine to process electronic data according to a selected multifactor authentication paradigm,
wherein the multifactor authentication paradigm comprises the verification of a mobile communications device and the verification of a personal identification number or code delivered using the mobile communications device.

2. The system as recited in claim 1 wherein multifactor authentication engine comprises a computing environment.

3. The system as recited in claim 2 wherein the instruction set comprises a computing application operable on a computing environment.

4. The system as recited in claim 3 further comprising a data store cooperating with the multifactor authentication engine to verify a mobile communications device and a personal identification number or code delivered using the mobile communications device.

5. The system as recited in claim 4 further comprising one or more communications networks selected from the following group: a fixed wire network, a wireless network, a mobile communications network, a debit network, a credit network, a network used for processing electronic payments and the Internet.

6. The system as recited in claim 1 wherein the multifactor authentication engine is operated by a payments processor, a financial institution, a credit reporting agency or by an entity which has contracted with a payments processor, a financial institution or a credit reporting agency.

7. A method for authenticating the identity of a user attempting a financial transaction comprising:
receiving a submitted first data set from a user attempting a financial transaction;
authenticating the submitted first data set against a known first data set, wherein the known first data set contains information associated with the user, rejecting the financial transaction should the authentication of the submitted first data set fail;
submitting a request for a second data set to the user;
receiving a submitted second data set from the user;
authenticating the submitted second data set against a known second data set, wherein the known second data set contains information associated with the user, rejecting the financial transaction should the authentication of the submitted second data set fail; and
allowing the financial transaction to proceed should the submitted first data set and the submitted second data be properly authenticated.

8. The method as recited in claim 7 in which the financial transaction comprises any of a transaction undertaken at an automated teller machine, accessing a user account through an online banking portal, a transaction undertaken at a point of sale system, and a transaction undertaken with a credit reporting agency.

9. The method as recited in claim 7 in which the submitted first data set is delivered an instrumentality comprising any of a credit card, a debit card, a barcode, a magnetic stripe, a near-field communications device, a radio frequency identification device, an Internet webpage, and by the submission of user-identification data known to a credit reporting agency.

10. The method as recited in claim 7 in which the request for a second data set is submitted to the user using one or more instrumentalities comprising a text message delivered by the short message service and a multimedia message delivered by the multimedia message service.

11. The method as recited in claim 7 in which the submitted second data set is submitted by the user using one or more instrumentalities comprising a text message delivered by the short message service, a multimedia message delivered by the multimedia message service, and as a one-time use personal identification number inputted into an automated teller machine or a point of sale device.

12. The method as recited in claim 7 in which the submitted second data set comprises a personal identification number.

13. The method as recited in claim 7 in which the submitted second data set comprises data identifying the user's mobile phone.

14. A computer readable medium having computer readable instructions to instruct a computer to perform a method for authenticating the identity of a user attempting a financial transaction comprising:
receiving a submitted first data set from a user attempting a financial transaction;
authenticating the submitted first data set against a known first data set, wherein the known first data set contains information associated with the user, rejecting the financial transaction should the authentication of the submitted first data set fail;
submitting a request for a second data set to the user;
receiving a submitted second data set from the user;
authenticating the submitted second data set against a known second data set, wherein the known second data set contains information associated with the user, rejecting the financial transaction should the authentication of the submitted second data set fail; and
allowing the financial transaction to proceed should the submitted first data set and the submitted second data be properly authenticated.

15. The computer readable medium as recited in claim 14 in which the financial transaction is a transaction comprises any of a transaction undertaken at an automated teller machine, accessing a user account through an online banking portal, a transaction undertaken at a point of sale system, and a transaction undertaken with a credit reporting agency.

16. The computer readable medium as recited in claim 14 in which the submitted first data set is delivered by one or more instrumentalities comprising a credit card, a debit card, a barcode, a magnetic stripe, a near-field communications device, a radio frequency identification device, an Internet webpage, and the submission of user-identification data known to a credit reporting agency.

17. The computer readable medium as recited in claim 14 in which the request for a second data set is submitted to the user using one or more instrumentalities comprising a text message delivered by the short message service, and a multimedia message delivered by the multimedia message service.

18. The computer readable medium as recited in claim 14 in which the submitted second data set is submitted by the user using one or more instrumentalities comprising a text message delivered by the short message service, a multimedia message delivered by the multimedia message service, and a one-time use personal identification number inputted into an automated teller machine or a point of sale device.

19. The computer readable medium as recited in claim 14 in which the submitted second data set comprises a personal identification number.

20. The computer readable medium as recited in claim 14 in which the submitted second data set comprises data identifying the user's mobile phone.
